(19) United States
(12) Patent Application Publication
(10) Pub. No.: US 2009/0138550 A1
(43) Pub. Date: May 28, 2009

(54) DOWNLOADING SERVER WITH TWO PORTS AND ASSOCIATED METHOD

(75) Inventor: Eric Pageron, Deuil La Barre (FR)

Correspondence Address: DARBY & DARBY P.C., P.O. BOX 770, Church Street Station, New York, NY, 10008-0770, US

(73) Assignee: Thales, Neuilly sur Seine (FR)

(21) Appl. No.: 12/276,633

(22) Filed: Nov. 24, 2008

(30) Foreign Application Priority Data
Nov. 23, 2007 (FR) 07 08211

(51) Int. Cl. G06F 15/16

(52) U.S. Cl. 709/203

(57) ABSTRACT

The invention is directed to a device and a method for loading files onto a remote application which uses a standard protocol of the http type while making it possible to track the progress of said loading. For this purpose, there is provided a second port which enables the measurement, performed on the server where the application is located, of the progress to be displayed. The invention is particularly useful for operating and maintaining applications onboard an aircraft, for which the standards prescribed by airlines require progress tracking for transfers in both directions.

### FIELD OF THE INVENTION

The present invention belongs to the field of devices and methods for downloading files onto a remote application. More particularly, the invention makes it possible to provide the user with a significant functionality for tracking progress when exporting files to this remote application within the framework of the use of the http protocol, the standard for exchanges on the Internet.

### BACKGROUND

Today, only the progress od importing of files can be tracked on the client. Thus, this protocol cannot be used for applications which require progress tracking for file loads in both directions. This is notably the case with regard to the maintenance of applications, critical or non-critical, onboard aircraft. The standard applicable to downloads to airborne applications linked with an Ethernet network is the ARINC (Aeronautical Radio Inc.) 615A standard entitled “Software data loader using Ethernet interface”. The 665-1 standard on downloadable software is also applicable in that it determines the exchange formats, notably the file headers, and the integrity checking processes. The ARINC 615A standard requires, in particular, progress checking for transfers in both directions. Http therefore not being applicable, the standard recommends the use of a specific protocol, TFTP (Trivial File Transfer Protocol). This specific feature imposes the use of proprietary clients whose licences have a high cost, thereby posing a problem to numerous users

The present invention solves this problem by making it possible to track the progress of the downloading of files to a remote application by the standard http protocol.

### SUMMARY OF THE INVENTION

For this purpose the invention discloses a server for loading files to an application module from a client residing on a computer equipment connected to the server by a communication network, said server using a protocol of the http type, wherein the progress status of the transactions on a first port is transmitted to the client through a communication on a second port.

The invention also discloses a downloading method associated with the server.

The invention which uses a standard and open protocol furthermore exhibits the advantage of alleviating another drawback of the TFTP proprietary protocol, the upgradability of which is low, the maintenance clients not being furnished with interface programming tools (API) allowing adaptation to the user's requirements.

### BRIEF DESCRIPTION OF THE DRAWINGS

The invention will be better understood and its various characteristics and advantages will emerge from the following description of several exemplary embodiments in cases of application of the A615A standard and its appended figures in which:

FIG. 1 represents the architecture of the download server according to the invention;

FIG. 2 represents the sequencing of the processing of the method according to the invention;

FIG. 3 represents the sequencing of the processing of the method according to the invention in the mode of loading a file to the remote application;

FIG. 4 represents the sequencing of the processing of the method according to the invention in the mode of unloading a file from the remote application;

FIG. 5 represents the sequencing of the processing of the method according to the invention in the mode of unloading a list of files from the remote application;

FIG. 6 represents the sequencing of the processing of the method according to the invention in the mode for providing information on the files present on the remote application.

### DETAILED DESCRIPTION OF PREFERRED AND OTHER EMBODIMENTS

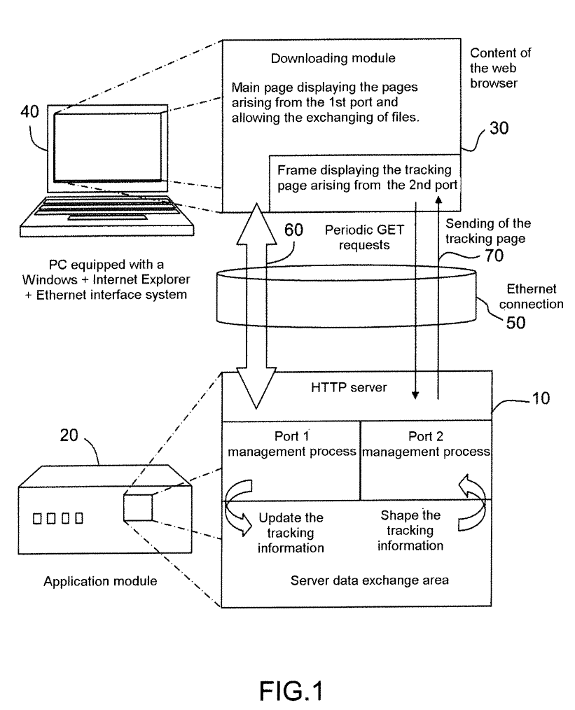

In FIG. 1, the server 10 installed on a first computer equipment 20 serves to manage the downloads of files necessary for maintaining or using an application module installed on the equipment 20. These downloads are managed by a user who, in order to do so, uses a downloading module 30 installed on a second computer equipment 40 which may be a portable or fixed PC or a specific item of hardware. The computer equipments 20, 40 are linked together by a connection 50 which may for example be an Ethernet network. Other networks are conceivable, for example a wire telephone network of STN (Switched Telephone Network) or ADSL (Asymmetric Digital Subscriber Line) type or even an RF connection (Wi-Fi, private network or public telephone network). The http protocol allows pages to be exchanged between a client (here the module 30 installed on the equipment 40) and a server (here the server 10 installed on the equipment 20). A user of 40 is able to unload files residing on the facility 20 (“Download” function). He can also transfer files from his station to the facility 20 (“Upload” function). In the first case, there is no difficulty in tracking the progress of the transfer of the file since the download module is informed right from the start of the transfer of the size of the expected file and the progress measurement is performed on reception on the client station which can permanently display the transfer ratio and/or its absolute value. Knowing furthermore the mean throughput of the network connecting the facilities, it is also possible to display the expected duration at the moment at which the transfer starts and the time remaining during transfer. In the second case of transfer from the client to the server, the knowledge by the client station of the progress of the transfer to the server would presuppose the communication from the server to the client of information formulated on said server. Specifically, the actual progress of the upload is available only at the network output on the equipment 20. Any information formulated on the client without information on what has actually arrived at the server is necessarily false. Now, the transfer of files under http would necessarily be interrupted by the sending of information on the progress status from 20 to 40 on the same communication port. Hence the idea of the invention to use a second port 81 to transfer the progress information from 20 to 40, although the transfer itself uses a first port 80. It is possible to open several communication ports on an http server. In fact, for security reasons, it is often preferable to limit the possibilities of communications between a server connected to the Internet network to a single port. This limitation does not exist in the case of servers connected to a private network. Furthermore, in the case of servers connected to the Internet, it is possible to open several ports, on condition that the precautions necessary to filter accesses via all the open ports are taken.

As indicated in FIG. 1, in the case where two ports are open on the http server installed on the facility 20, one 80 (this is in fact the default address of an open port on an http server) is dedicated to the exchange of data, the other port 81 to communicating to the client the tracking information, formulated and shaped on the http server. The page comprising this tracking information (rate of progress, volume and optionally estimation of a remaining time) is transmitted on the network to the client station 40 in response to GET requests sent periodically, for example every 5 seconds, by the module 30 to the server 10.

The downloading method of the invention alleviates a significant drawback of the http protocol, for example when a user has to transfer voluminous files to an Internet site, as is the case for individuals in sites for compiling photograph albums. It is also very advantageous in the case of applications which require, for control reasons, tracking of progress in both directions of downloading, as is the case with avionics applications. Today, because of the above-indicated limitations of the http protocol, the ARINC 615A standard prescribes the use of a TFTP proprietary protocol. To the drawbacks already indicated previously (cost of the licences, absence of API), must be added a certain slowness of upgrade which implies that the latest, most reliable security mechanisms for authentication and secure transfer are integrated into this protocol only after some delay. The invention makes it possible to dispense with the use of this proprietary protocol and to use the http protocol while satisfying the other constraints of the A615A standard. The proposed solution is the creation of an http server with dual input (2 listening ports) using the files of the A615A and A665 standards to manage the downloads:
the 1^{st} port (whose value is 80 by default) is the main port for data exchange
the 2^{nd} port (whose value is free) is a port which serves solely for uploading the tracking information (status, download progress, etc.)

The server responds to all the http requests on its 1^{st} port. On the 2^{nd} port, it accepts any type of request but always returns the same html page containing the information necessary for tracking the progress of the transaction carried out on the 1^{st} port. With this type of server, the use of the http protocol and of Web clients becomes possible for downloading software onto an avionics module. It is possible to use any computer equipped with an Ethernet interface and with a Windows type operating system. The embedded application (the http server) is responsible for managing the man/machine interface and all the aspects of the transfer. Finally, the manufacturer of the module has the possibility of customizing at will the interface offered to the operator responsible for downloading and of providing upgraded services such as secure access for example. Web interface production costs are very low. This interface can be very simple or very sophisticated.

The A615A standard makes provision for a minimum of four functions: an “upload” function, a “download” function, a “Media defined download” function for collectively unloading a predetermined list of files residing on the application module and an “information” function for making available, on the client, information relating to the files present on the application module. Thus a minimum of five URL (Uniform Resource Locator) addresses will be available on the port 80, the addresses themselves being given purely by way of illustration:

The index (Ex: http://10.0.3.1/): Home page of the download software. This page displays the characteristics of the module (Identification TARGET_HW_ID, TARGET_TYPE, Name and Logo of the constructor), the services offered (upload, download, Media defined download, information);

Upload (Ex: http://10.0.3.1/upload): Page allowing a file to be downloaded from the client to the application module;

Download (Ex: http://10.0.3.1/download): Page allowing a file to be downloaded from the application module to the client. This page must offer only software authorized for this type of transfer (Event Log, Fault Log, Databases);

Information (Ex: http://10.0.3.1/information): Page displaying the detailed list of software present in the module with its part-number, its description, etc.

Media defined download (Ex: http://10.0.3.1/mediadefineddownload): Page allowing a predefined list of software to be downloaded from the client to the module. When the list is received in full, the server returns the requested files to the client.

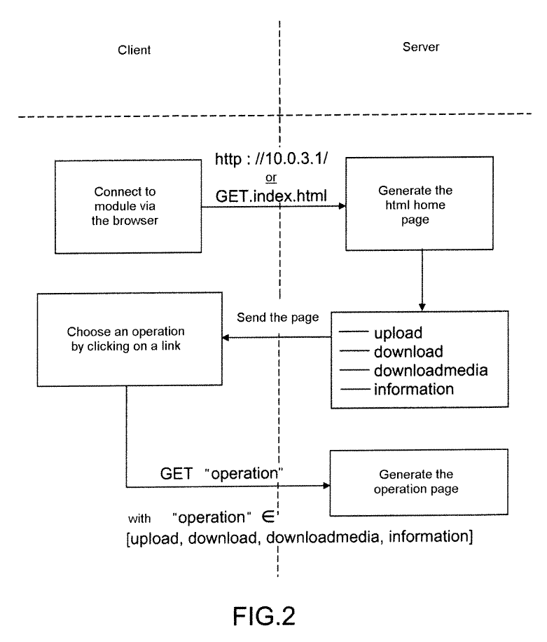

The flowchart of the processing allowing the initialization of these four functions is represented in FIG. 2. The user initializes a connection on his Web browser by re-entering the URL of the index or by running the function GET.index.html. This connection can be preceded by an authentication phase. The http server then generates the html home page comprising at the minimum the four functions of the standards, the page thereafter being sent to the client. The user then chooses the operation to be carried out. This choice generates a GET command to the server which then generates the corresponding page.

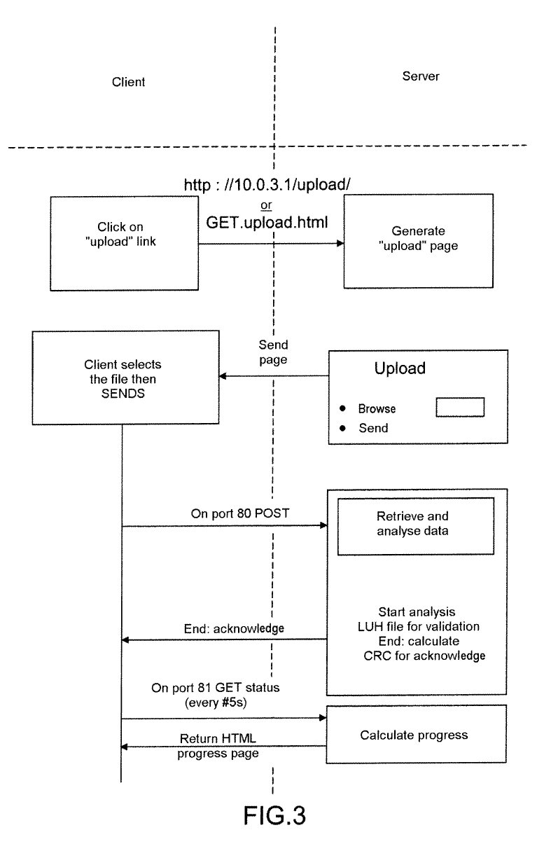

FIG. 3 represents the flowchart of the processing of the “Upload” function. The “Upload” page generated on the server is transmitted to the client. It allows the user to select the file to be transferred from the client to the server. When the selection is confirmed, a POST “File” request encoded in the multipart/form-data format is transmitted on the port 80 to the server. In the case of avionics applications for which the format of the files is governed by the ARINC 665 standard, an encapsulation file, for example a TAR (Tape ARchiver) file, is generated on the basis of all the files constituting the LOAD within the meaning of the standard. The first file of the packet must necessarily be a file equivalent to the LUH (Load Upload Header) file of this standard which has a determined format. The data retrieval and analysis function is then activated on the server. At the start of transfer, the file header is analysed to verify the compatibility of the file to be transferred with the application on which the download server is installed. During transfer, CRCs (Cyclic Redundancy Codes) are calculated per data block. At the end of transfer, a global CRC is calculated on the basis of the partial CRCs so as to confirm the integrity of the data transferred. In parallel, periodic GET Status requests pass over the port 81 and generate the calculation of the rate of progress on the server and the return to the client of an html page comprising this information. When an operation has commenced, the server must systematically return upon any GET request on the second port a Web page indicating:

the progress of the download

the estimated time remaining

a button enabling cancellation of the operation

The first port serves solely for data transfer. No page may be transmitted by the server on this port during the operation. The data displayed on the page transferred on the second port originate from the process which manages the transfer currently under way on the first port. This page may be

either displayed in a pop-up window different from the main window of the Web browser. This pop-up window must be created automatically by the home page at the 1^{st} connection. It being possible for the user to close this pop-up in error, the home page must offer a means of restoring it.

or displayed in a different frame from the frame of the home page. In this case, the main screen of the browser is divided into 2 distinct parts. There is no risk of the user deleting the page.

or displayed on demand if the user types the URL of the 2^{nd} port into a new window of his WEB browser.

The http header of the page must necessarily contain a mechanism making it possible to automatically ask the server to refresh the data of the page:

either through the HTML code as <META HTTP-EQUIV=“Refresh” CONTENT=“3;URL=http://10.0.3.1:81/”>

or through the javascript code with the setTimeout command.

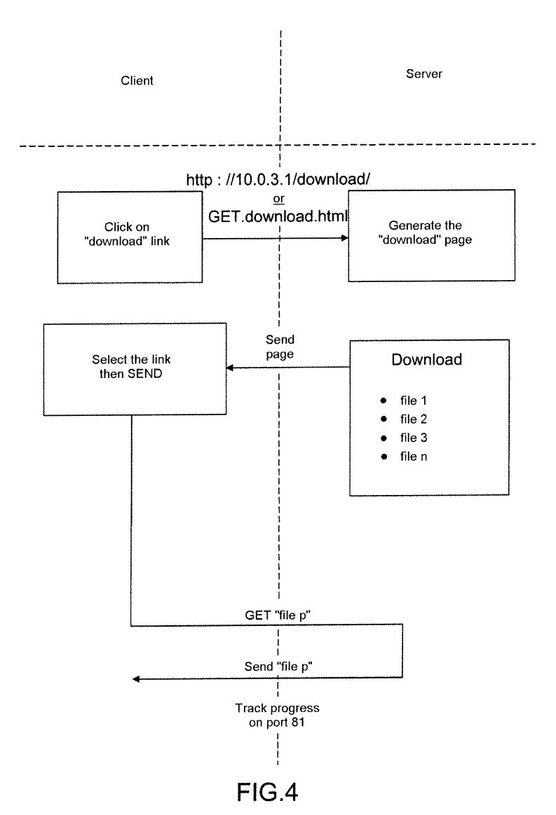

FIG. 4 represents the flowchart of the processing of the “Download” function. The file to be transferred by the server is selected on an html page generated on the http server and transmitted to the client which comprises the list of links to the transferable files. Clicking on one of the links generates a GET command to the server which launches the transfer of the selected file. In this direction, progress tracking can be carried out on the same port since the information is available on the client.

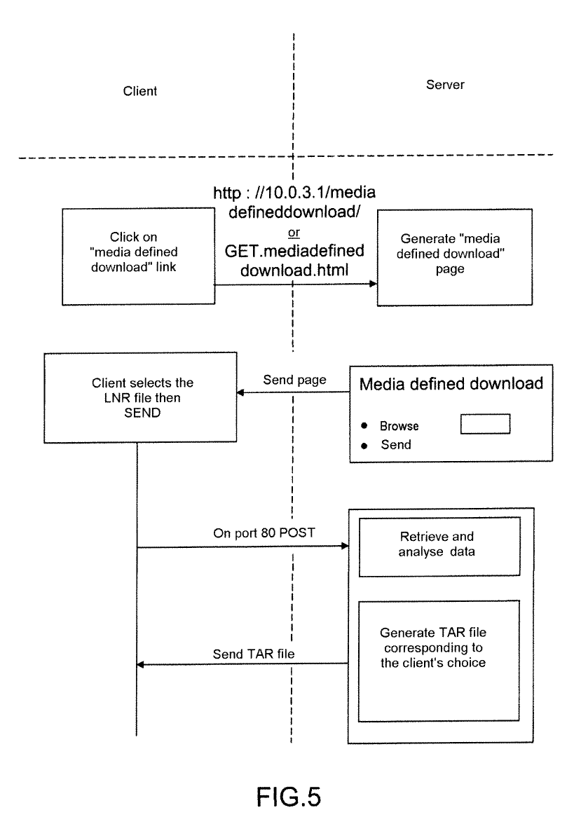

FIG. 5 represents the flowchart of the processing of the “Media defined download” function. This function allows the grouped unloading of several files corresponding to usual procedures defined for each application. These files are grouped together in LNR files which are selected by the user on a list transmitted from the server to the client by an html page. Sending is preceded by an error check (file name unknown).

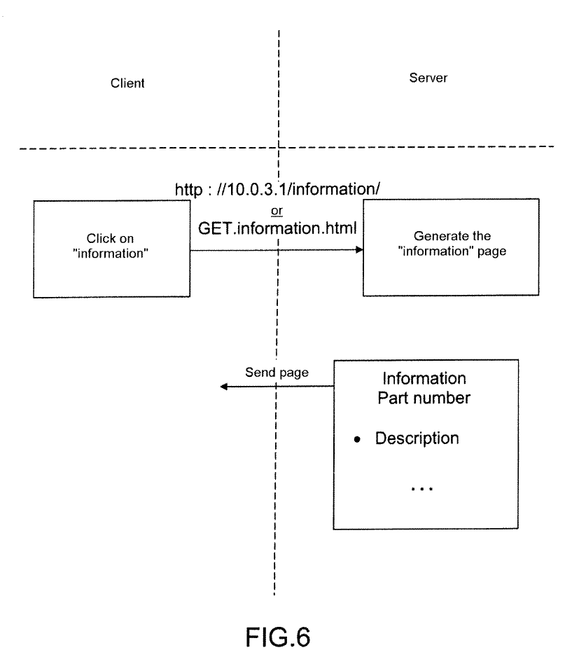

FIG. 6 represents the flowchart of the processing of the “Information” function. This function allows consultation of an html page formulated on the server which comprises a list of information specified by the 615A standard.

The exemplary embodiments given do not in any way decrease the generality of the claimed invention which applies to any application context from the moment at which information relating to tracking the progress of the load from a client to a server using a first http port is formulated on the server and transmitted on a second port of the said server.

1. An http server for loading files to an application module from a client residing on a computer equipment by use of a transfer, comprising:
a first port connected to the application module; and
a second port connected to the communication network, wherein the computer equipment is connected to the communication network,
wherein the http server is configured to transmit a progress of the transfer by use of a communication to the client.

2. The http server of claim 1 wherein the http server is configured to make loading of the files onto the application module subject to prior authorization before the start of the transfer.

3. The http server of claim 2 wherein said prior authorization is based on an analysis of the compatibility of the files to be transferred with the application module.

4. The http server of claim 1 wherein the loading of the files onto the application module includes an acknowledgement after an end of the transfer.

5. The http server of claim 4 wherein the acknowledgement after the end of the transfer is sent after checking an integrity of transferred file elements.

6. The http server of claim 1 further comprising at least one mode chosen from functions selected from a group consisting of loading files onto the remote application, unloading files from the remote application, unloading a set of files from the remote application, and providing information on the files present on the remote application.

7. A method for loading files to an application module from a client residing on a computer equipment by use of a transfer, comprising:
connecting a first port to the application module;
connecting a second port to the communication network, wherein the computer equipment is connected to the communication network;
loading files from the second port to the first port; and
transmitting a progress of the transfer by use of a communication to the client.

8. The method of claim 7, further comprising the step of:
authorizing the step of loading files prior to start of the transfer, by use of a prior authorization.

9. The method of claim 8 wherein said prior authorization is based on an analysis of the compatibility of the files to be transferred with the application module.

10. The method of claim 7, comprising the further step of acknowledging the loading of the files onto the application module after an end of the transfer, by use of an acknowledgement.

11. The method of claim 10 wherein the acknowledgement after the end of the transfer is provided after checking an integrity of transferred file elements.

12. The method of claim 7 further comprising at least one mode chosen from functions selected from a group consisting of loading files onto the remote application, unloading files from the remote application, unloading a set of files from the remote application, and providing information on the files present on the remote application.
